(19) United States
(12) Patent Application Publication
(10) Pub. No.: US 2009/0088278 A1
(43) Pub. Date: Apr. 2, 2009

(54) ANNULAR METAL CORD, ENDLESS METAL BELT, AND ANNULAR METAL CORD MANUFACTURING METHOD

(75) Inventors: Hiroshi Sasabe, Utsunomiya-shi (JP); Hitoshi Wakahara, Utsunomiya-shi (JP); Yuichi Sano, Utsunomiya-shi (JP); Kenichi Okamoto, Itami-shi (JP)

Correspondence Address: OSHA LIANG L.L.P., TWO HOUSTON CENTER, 909 FANNIN, SUITE 3500, HOUSTON, TX, 77010, US

(73) Assignees: SUMITOMO (SEI) STEEL WIRE CORP., Itami-Shi, Hyogo (JP); SUMITOMO ELECTRIC TOCHIGI CO., LTD., Utsunomiya-Shi, Tochigi (JP)

(21) Appl. No.: 12/160,207

(22) PCT Filed: Sep. 5, 2007
(86) PCT No.: PCT/JP2007/067337

§ 371 Date: Jul. 7, 2008

(30) Foreign Application Priority Data
Sep. 5, 2006 (JP) 2006-240166
Feb. 28, 2007 (JP) 2007-050569
Mar. 2, 2007 (JP) 2007-053062
Apr. 25, 2007 (JP) 2007-116047
Jun. 4, 2007 (JP) 2007-148299

(51) Int. Cl. B21F 43/00; B21C 37/04; D07B 1/06; F16G 1/18

(52) U.S. Cl. 474/202; 428/592; 57/213; 57/13

(57) ABSTRACT

An annular metal cord includes an annular core portion formed in an annular shape, and an outer layer portion spirally wound around the annular core portion while running over an annular circumference thereof plural times and covering an outer peripheral surface of the annular core portion. Each of the annular core portion and the outer layer portion are formed by a strand material which is formed by intertwisting a plurality of metal filaments. The annular core portion and the outer layer portion are formed by a continuous strand material.

### TECHNICAL FIELD

The present invention relates to an annular metal cord, an endless metal belt, and a method of producing the annular metal cord.

### BACKGROUND ART

Hitherto, as a type of endless metal belt, there has been known, as is described, for example, in Patent Document 1, an endless metal belt having a rectangular cross section which is produced by bending a rolled strap material, welding both ends thereof together into a cylindrical shape, and cutting it at a predetermined width.

In addition, as is described, for example, in Patent Document 2, there is known an endless belt in which a metal cord is used as a core material. The metal cord, which constitutes the core material, includes at least one filament serving as a central core and a plurality of filaments which are wound around the central core.

Patent Document 1: Japanese Unexamined Patent Application Publication No. 2003-236610

Patent Document 2: Japanese Unexamined Patent Application Publication No. 4-307146

### DISCLOSURE OF INVENTION

### Problems to be Solved by the Invention

Since the endless metal belt described in Patent Document 1 has the rectangular cross section, the endless metal belt is susceptible to torsion and is apt to break. Also, when the metal cord described in Patent Document 2 is applied to an endless metal belt, both end portions of the metal cord need to be joined together to form an annular shape. As a practically conceivable method for joining together both the end portions of the metal cord, there are a method of joining together both the end portions of the metal cord in an abutted state, and a method of joining together both end portions of each of filaments which constitute the metal cord. With the method of joining together both the end portions of the metal cord in an abutted state, since a resulting annular metal cord is joined at a single concentrated location in the circumferential direction, a complete break of the annular metal cord is liable to occur. On the other hand, with the method of joining together both the end portions of each of the filaments, since the end portions of the filament have to be joined together after they are untwisted and then the end portions of the filament have to be re-twisted after they have been joined together, the twisted state differs between the joined portion and the other portion of a resulting annular metal cord, thus causing a fear that the mechanical strength of the joined portion is decreased. As a result, the metal cord is apt to break. In addition, with the method of joining together both the end portions of each of the filaments, the joining process is complex and troublesome, which causes a difficulty in producing the annular metal cord.

Accordingly, an object of the present invention is to provide an annular metal cord and an endless metal belt, which are hard to break and easy to produce, as well as a method of producing the annular metal cord.

### Means for Solving the Problems

An annular metal cord according to the present invention, which is capable of solving the above-described problems, comprises an annular core portion formed in an annular shape, and an outer layer portion spirally wound around the annular core portion while running over an annular circumference thereof plural times and covering an outer peripheral surface of the annular core portion, each of the annular core portion and the outer layer portion being formed by a strand material which is formed by intertwisting a plurality of metal filaments, wherein the annular core portion and the outer layer portion are formed by a continuous strand material.

Thus, the strand material formed by intertwisting the plurality of metal filaments is used to form each of the annular core portion and the outer layer portion which is spirally wound around the annular core portion while running over the annular circumference thereof plural times and covering the outer peripheral surface of the annular core portion, and the annular core portion and the outer layer portion are both formed by the continuous strand material. Therefore, the annular metal cord can be made sturdy and a possibility that the annular metal cord is completely broken can be avoided in contrast to the related art in which a plurality of strand materials are joined respectively at their both ends at one concentrated location in the circumferential direction. Further, since external forces applied to the annular metal cord can be borne by the annular core portion and the outer layer portion which are continuous in the form of one strand material, the applied external forces can be dispersed over the entire annular metal cord so as to avoid local concentration of load. Consequently, since the annular core portion is formed by using the strand material as it is and the strand material is continuously wound around the annular core portion serving as an axial core, the annular metal cord having high break strength can be obtained.

Moreover, when forming the outer layer portion, the strand material constituting the annular core portion is continuously wound around the annular core portion while running over its annular circumference plural times instead of winding a plurality of strand materials. Hence, a single strand material is just required. In comparison with the case using a plurality of strand materials, therefore, the number of points at which the strand materials are joined respectively at their both ends can be reduced, whereby a reduction of break strength of the annular metal cord can be suppressed and production thereof can be facilitated. Further, by winding the strand material constituting the outer layer portion at a predetermined winding angle, the winding of the strand material can be performed free from disorder and the annular metal cord having a substantially uniform surface state can be obtained. The annular metal cord having such a surface state is prevented from undergoing forces externally applied to a particular concentrated location and is evenly subjected to the externally applied forces, whereby a reduction of the break strength can be further suppressed.

Preferably, the annular core portion and the outer layer portion are formed by a single strand material and both ends of the strand material are joined together. With that feature, the number of joined points is reduced to one, i.e., smaller than that in the case using a plurality of strand materials. Therefore, a reduction of break strength of the annular metal cord can be suppressed and production thereof can be facilitated. Further, since a joined portion has a cross-sectional area just corresponding to one strand material, a load difference can be reduced which is generated between the joined portion and the other portion when the annular metal cord is bent, thereby suppressing a reduction of the break strength.

Preferably, one end of the strand material is a start end from which the annular core portion starts to be formed, and the other end of the strand material is a terminal end at which the formed outer layer portion is terminated. With that feature, the annular metal cord having high break strength can be obtained in which the start end of the strand material forming the annular core portion and the terminal end of the strand material forming the outer layer portion are joined together.

Alternatively, one end of the strand material may be left as an extra extension when the annular core portion is formed, and the extra extension may constitute part of the outer layer portion. With that feature, the annular metal cord having high break strength can be obtained in which the end of the extra extension left when the annular core portion is formed and the terminal end of the strand material are joined together, and the extra extension serves as part of the outer layer portion.

Preferably, the metal filament has a diameter of not smaller than 0.06 mm, but not larger than 0.40 mm. With that feature, the strand material can be made to have appropriate rigidity and hence satisfactory fatigue resistance. More preferably, the metal filament has a diameter of not smaller than 0.06 mm, but not larger than 0.22 mm.

Preferably, a twisting direction of the metal filaments is opposed to a winding direction of the outer layer portion wound around the annular core portion. With that feature, the annular metal cord can be obtained which has less ruggedness in surface appearance after the winding of the strand material. Further, the annular metal cord being less susceptible to torsion can be obtained.

Preferably, a winding angle of the strand material with respect to a center axis of the annular core portion is not smaller than 4.5 degrees, but not larger than 13.8 degrees. With that feature, the operation of winding the strand material is facilitated. Further, the annular metal cord having appropriate elongation and causing no loosening of the wound strand material can be obtained.

Preferably, the strand material is wound along the outer peripheral surface of the annular core portion while running over an annular circumference thereof five or six times. Alternatively, the strand material is wound into an annular shape three rounds to form the annular core portion and is wound along the outer peripheral surface of the annular core portion while running over an annular circumference thereof not less than seven, but not more than nine times. With those features, since the outer layer portion closely covers the annular core portion, the annular metal cord can be obtained in a geometrically stable structure. As a result, the annular metal cord can be certainly obtained which has superior break strength and is endurable against deformations in the radial direction.

When the strand material is wound into an annular shape three rounds to form the annular core portion and is wound along the outer peripheral surface of the annular core portion while running over an annular circumference thereof not less than seven, but not more than nine times, the strand material constituting the outer layer portion is preferably wound in a direction opposed to the winding direction of the annular core portion. However, even when the strand material is wound in the same direction in both the annular core portion and the outer layer portion, the strand material constituting the outer layer portion can be prevented from falling into between adjacent twist turns of the strand material constituting the annular core portion by setting the winding pitch of the annular core portion to be small and the winding pitch of the outer layer portion to be large (namely, by setting a large difference in the winding pitch between the annular core portion and the outer layer portion).

Preferably, the annular core portion and the outer layer portion are subjected to a low-temperature annealing process. With that feature, internal strains of the metal filament can be removed.

Preferably, ends of the strand material are joined together by using a connecting member. With that feature, the joined portion of the annular metal cord can be made harder to break.

Preferably, the ends of the strand material are joined together by welding and a joined portion of the strand material is covered with the connecting member which is made of a sleeve in the form of a coil spring and is bonded to the joined portion. With that feature, the ends of the strand material can be more easily joined together and the joined point can be protected and reinforced by the connecting member. Further, since the coil spring sleeve has superior flexibility, the connecting member is pliably deformed in conformity with a bent shape of the spirally wound strand material so as to maintain a state of close contact against the joined portion of the strand material, and it does not impede deformation of the strand material in the joined portion. Consequently, mechanical characteristics of the annular metal cord can be made substantially uniform over its entire circumference.

Preferably, the ends of the strand material are overlapped with each other in an axial direction and are held inside the connecting member made of a sleeve in the form of a coil spring, which has a sleeve inner diameter smaller than twice the diameter of the strand material. With that feature, the ends of the strand material can be more easily joined together. Further; since the coil spring sleeve has superior flexibility, the connecting member is pliably deformed in conformity with a bent shape of the spirally wound strand material so as to maintain a state of close contact against the connected portion of the strand material, and it does not impede deformation of the strand material in the connected portion. Consequently, mechanical characteristics of the annular metal cord can be made substantially uniform over its entire circumference. In addition, since the connecting member has the sleeve inner diameter smaller than twice the diameter of the strand material, a compressive force (tightening force) is generated to act on both the ends of the strand material, which are overlapped with each other inside the connecting member, from the connecting member. Therefore, both the ends of the strand material are securely connected together by frictional forces between the connecting member and the strand material and between both the ends of the strand material. Moreover, even when a tensile force acts on the connected portion, the coil spring sleeve is caused to extend in the axial direction, thus enabling both the ends of the strand material to be further strongly compressed and tightened. As a result, a stable connected state can be maintained.

Preferably, the connecting member is made of a sleeve in the form of a close-wound coil spring. With that feature, in comparison with a spring having a coil gap, a force acting to tighten both the ends of the strand material can be more securely maintained even when the strand material is bent at a smaller radius of curvature. Further, since the number of coil windings per unit length is increased, both the ends of the strand material can be more securely held in a tightened state.

Preferably, a spring wire constituting the connecting member has a larger diameter than the metal filament. In order to tighten both the ends of the strand material for secure connection, the spring wire constituting the connecting member is required to have a certain degree of strength. By setting the diameter of the spring wire to be larger than that of the metal filament constituting the strand material, the strength of the connecting member can be more easily obtained at a level required to maintain the securely connected state.

Preferably, both the ends of the strand material are intertwisted in a connected overlap portion to be plastically deformed therein for connection between both the ends. With that feature, another additional member for establishing the connection is not required and a projection appearing on the cord surface can be minimized. Therefore, the annular metal cord can be suitably used, for example, in a drive transmission belt for an industrial machine.

Preferably, an intertwisting direction of the strand material in the connected overlap portion is the same as a twisting direction of the metal filaments in the strand material. With that feature, the strand material can be easily plastically deformed at a less number of times of twists without causing untwisting. As a result, both the ends of the strand material can be connected together at higher strength and its fatigue strength can also be improved.

Preferably, the connected overlap portion is located substantially intermediate between an inner periphery and an outer periphery of the annular metal cord. Thus, by arranging the connected overlap portion at a position substantially intermediate the inner and outer peripheries of the annular metal cord where tensile forces and compressive forces act at minimum, even when the annular metal cord is deformed in the radial direction, a load acting on the connected overlap portion can be reduced and a break in the connected overlap portion can be suppressed.

Preferably, the strand material is twisted two to five times in the connected overlap portion. With that feature, both the ends of the strand material can be connected together at sufficient strength. In addition, variations in amount of plastic deformation of the strand material due to over-twisting can be reduced to suppress brittleness of the metal filaments, and the securely connected state can be maintained.

Also, an endless metal belt according to the present invention, which is capable of solving the above-described problems, is featured in employing the above-described annular metal cord according to the present invention. By employing the above-described annular metal cord, the endless metal belt can be obtained which is superior in break strength and fatigue resistance and which is easy to produce.

Further, a producing method, which is capable of solving the above-described problems, resides in a method of producing an annular metal cord comprising an annular core portion formed in an annular shape, and an outer layer portion spirally wound around the annular core portion while running over an annular circumference thereof plural times and covering an outer peripheral surface of the annular core portion, wherein, in a state that a strand material formed by intertwisting a plurality of metal filaments is wound into an annular shape with a predetermined diameter and is temporarily fixed at a start end thereof or part thereof near the start end to form the annular core portion, the strand material is spirally wound around the annular core portion while running over an annular circumference thereof plural times, thereby forming the outer layer portion to cover the outer peripheral surface of the annular core portion, and the start end and a terminal end of the strand material are then joined together.

Thus, by the method of, in the state that the strand material formed by intertwisting a plurality of metal filaments is wound into the annular shape with the predetermined diameter and is temporarily fixed at the start end thereof or part thereof near the start end to form the annular core portion, spirally winding the strand material around the annular core portion while running over the annular circumference thereof plural times, thereby forming the outer layer portion to cover the outer peripheral surface of the annular core portion, and then joining together the start end and the terminal end of the strand material, a sturdy annular metal cord can be produced and a possibility that the annular metal cord is completely broken can be avoided in contrast to the related art in which a plurality of strand materials are joined respectively at their both ends at one concentrated location. Consequently, since the annular core portion is formed by using the strand material as it is and the strand material is continuously wound around the annular core portion serving as an axial core, the annular metal cord having high break strength can be obtained.

Moreover, when forming the outer layer portion, the strand material constituting the annular core portion is continuously wound around the annular core portion while running over its annular circumference plural times instead of winding a plurality of strand materials. Hence, a single strand material is just required. In comparison with the case using a plurality of strand materials, therefore, the number of points at which the strand materials are joined respectively at their both ends can be reduced, whereby a reduction of break strength of the annular metal cord can be suppressed and production thereof can be facilitated. Further, the strand material constituting the outer layer portion can be wound to form the outer layer portion with substantially no gaps left. In addition, by winding the strand material constituting the outer layer portion at a predetermined winding angle, the winding of the strand material can be performed free from disorder and the annular metal cord having a substantially uniform surface state can be obtained. The annular metal cord having such a surface state is evenly subjected to the externally applied forces, whereby a reduction of the break strength can be further suppressed.

Preferably, the method includes the steps of, after forming the outer layer portion, putting the start end and the terminal end of the strand material inside a connecting member and connecting both the ends together in a state overlapped with each other in an axial direction, the connecting member being made of a sleeve in the form of a coil spring, which has a sleeve inner diameter smaller than twice the diameter of the strand material, and cutting and removing respective extra extensions of the start end and the terminal end of the strand material, which are exposed outside the connecting member. With that feature, the ends of the strand material can be more easily joined together. Further, since the coil spring sleeve has superior flexibility, the connecting member is pliably deformed in conformity with a bent shape of the spirally wound strand material so as to maintain a state of close contact against the connected portion of the strand material, and it does not impede deformation of the strand material in the connected portion. Consequently, mechanical characteristics of the annular metal cord can be made substantially uniform over its entire circumference. In addition, since the connecting member has the sleeve inner diameter smaller than twice the diameter of the strand material, a compressive force (tightening force) is generated to act on both the ends of the strand material, which are overlapped with each other inside the connecting member, from the connecting member. Therefore, both the ends of the strand material are securely connected together by frictional forces between the connecting member and the strand material and between both the ends of the strand material. Moreover, even when a tensile force acts on the connected portion, the coil spring sleeve is caused to extend in the axial direction, thus enabling both the ends of the strand material to be further strongly compressed and tightened. As a result, a stable connected state can be maintained.

In addition, since the extra end extensions of the start end and the terminal end, which are exposed outside the connecting member, are cut and removed, both the ends of the strand material in the connected portion can be held inside the connecting member such that the connected portion also has a similar shape to that of the other portion of the annular metal cord, thereby providing a substantially uniform structure in the annual direction.

Preferably, the method further includes the steps of, after forming the outer layer portion, inserting one of the start end and the terminal end of the strand material into the connecting member to penetrate from one end to the other end thereof, and moving a spring wire at the other end of the connecting member to widen a coil gap between the spring wire and another adjacent spring wire, inserting the other of the start end and the terminal end of the strand material into the widened coil gap, and moving the inserted other end of the strand material along the coil gap to reach the one end of the connecting member, whereby the start end and the terminal end of the strand material are put inside the connecting member and are connected together in the state overlapped with each other in the axial direction.

Thus, the start end and the terminal end of the strand material can be easily put inside the connecting member in the overlapped state, which has the sleeve inner diameter smaller than twice the diameter of the strand material, through the steps of inserting one of the start end and the terminal end of the strand material into the connecting member, inserting the other end of the strand material into the coil gap between the spring wires at the end of the connecting member, and moving the inserted other end of the strand material along the coil gap to reach the end of the connecting member on the side opposed to the side from which the other end of the strand material has been inserted.

Preferably, the method further includes the steps of, after forming the outer layer portion, inserting the start end of the strand material into the connecting member from one end thereof to reach an axial intermediate portion of the connecting member, drawing out the inserted one end through a coil gap between spring wires in the axial intermediate portion of the connecting member, inserting the terminal end of the strand material into the connecting member from the other end thereof to reach the axial intermediate portion of the connecting member, drawing out the inserted other end through the coil gap between the spring wires in the axial intermediate portion of the connecting member, moving the start end of the strand material, which is projected externally of the connecting member through the coil gap, along the coil gap to reach the other end of the connecting member, and moving the terminal end of the strand material, which is projected externally of the connecting member through the coil gap, along the coil gap to reach the one end of the connecting member, whereby the start end and the terminal end of the strand material are put inside the connecting member and are connected together in the state overlapped with each other in the axial direction.

Thus, the start end and the terminal end of the strand material can be easily put inside the connecting member in the overlapped state, which has the sleeve inner diameter smaller than twice the diameter of the strand material, through the steps of inserting respectively the start end and the terminal end of the strand material into the connecting member from the opposite ends thereof to reach the axial intermediate portion of the connecting member, drawing out both the inserted ends through the coil gap between the spring wires in the axial intermediate portion of the connecting member, moving each of both the ends along the coil gap to reach the other end of the connecting member on the side opposed to the side from which the relevant end of the strand material has been inserted.

Still further, a producing method, which is capable of solving the above-described problems, resides in a method of producing an annular metal cord in which an intertwisting direction of both the ends of a strand material in a connected overlap portion is the same as a twisting direction of the strand material, the method including the steps of arranging a pair of plate members in a spaced relation, each of the plate members having a pair of holding elements which are capable of holding the strand material and are formed in the plate member in a spaced relation, holding portions of the strand material near respective ends thereof by the holding elements of the plate members such that the strand material portions near the ends thereof are stretched between the plate members in the state overlapped with each other in the axial direction, and relatively rotating the plate members in opposed directions with a center of rotation located between the pair of holding elements of each plate member, whereby the strand material portions near the ends thereof are intertwisted between the pair of plate members to form the connected overlap portion in which the strand material portions near the ends thereof are plastically deformed for connection therebetween.

Thus, since both the ends of the strand material can be easily and securely connected together at a low cost through the steps of holding the strand material portions near the ends thereof by the holding elements of the plate members such that the strand material portions near the ends thereof are stretched between the plate members in the state overlapped with each other in the axial direction, and relatively rotating the plate members in opposed directions with a center of rotation located between the pair of holding elements of each plate member, the strand material portions near the ends thereof are evenly intertwisted between the pair of plate members.

Preferably, the plate member includes, as the holding element, a slit which is formed to be opened at an outer periphery of the plate member and to extend up to a position near the center of rotation, and the strand material is inserted into the slit to be held in the slit. With that feature, just by inserting the strand material into the slit, the strand material can be easily held by the slit which serves as the holding element.

Preferably, the plate member includes the slit as one of the holding elements and an insertion hole as the other of the holding elements, the insertion hole allowing insertion of the strand material through the same. Since the other holding element is formed by the insertion hole, the following advantage is obtained. When the strand material is inserted through and held by the insertion hole, the strand material can be certainly held at its outer periphery against an inner edge of the insertion hole in the step of intertwisting both the ends of the strand material, whereby both the ends of the strand material can be more evenly intertwisted in the connected overlap portion. Also, since the strand material can be easily removed from the pair of plate members by removing the strand material from the slits in the radial direction, operation efficiency can be increased.

Preferably, when the strand material portions near the ends thereof are intertwisted to be connected together, a twisting margin at each end of the strand material is set to be longer than the length of the connected overlap portion. With that feature, both the ends of the strand material can be certainly intertwisted and connected together in the connected overlap portion having a predetermined length.

Preferably, after intertwisting the twisting margins of the strand material to be plastically deformed, not-twisted extra extensions of the twisting margins are cut and removed. With that feature, both the ends of the strand material can be connected together in a state that the useless extra extensions are not left.

Preferably, when the ends of the strand material are intertwisted and connected together, a plurality of catching members are engaged with connection non-target portions of the strand material other than connection target portions thereof which are to be connected together, and the connection non-target portions are moved by the catching members in a direction away from the connection target portions. With that feature, both the ends of the strand material i.e., the connection target portions, can be easily intertwisted and connected together, and hence the connecting operation can be smoothened.

### ADVANTAGES

According to the present invention, the annular metal cord and the endless metal belt can be provided which have superior break strength and fatigue resistance and which are easy to produce, and the method of producing the annular metal cord can also be provided. Consequently, when the annular metal cord and the endless metal belt of the present invention are used in an industrial machine, the industrial machine can be made to have superior durability.

### BRIEF DESCRIPTION OF DRAWINGS

FIG. 1 is a perspective view of an annular metal cord according to an embodiment.

FIG. 2 is a perspective view showing the annular metal cord, radially sectioned, according to the embodiment.

FIG. 3 is a perspective view showing a state where a strand material is wound around an annular core portion while running over its annular circumference once, which is included in the annular metal cord according to the embodiment.

FIG. 4(a) is a radial sectional view showing the annular metal cord according to the embodiment, and FIG. 4(b) is a side view of the annular metal cord.

FIG. 5 is an enlarged perspective view showing part (connected portion) of the annular metal cord according to the embodiment.

FIG. 6 is an enlarged perspective view showing another example of part (connected portion) of the annular metal cord according to the embodiment.

FIG. 7 is an enlarged perspective view showing still another example of part (connected portion) of the annular metal cord according to the embodiment.

FIG. 8 is a perspective view showing one example of a production apparatus for producing the annular metal cord according to the embodiment.

FIG. 9 is a front view of the apparatus, shown in FIG. 8, showing, by solid lines, a state where a reel is positioned outside a loop of the annular core portion at one end of a cycle of swing motions of the annular core portion and, by chain lines, a state where the reel is positioned inside the loop of the annular core portion at the other end of the cycle of swing motions of the annular core portion.

FIG. 10 is a front view of the apparatus, shown in FIG. 8, showing contrary to FIG. 9, by solid lines, a state where the reel is positioned inside the loop of the annular core portion at one end of the cycle of swing motions of the annular core portion and, by chain lines, a state where the reel is positioned outside the loop of the annular core portion at the other end of the cycle of swing motions of the annular core portion.

FIG. 11 is a conceptual view showing a step of forming the annular core portion of the annular metal cord according to the embodiment.

FIG. 12 is a conceptual view showing, as viewed from above, a state of the reel being moved when the annular metal cord according to the embodiment is produced.

FIG. 13 is a perspective view showing successively a connection step when the annular metal cord according to the embodiment is produced.

FIG. 14 is a perspective view showing successively another connection step when the annular metal cord according to the embodiment is produced.

FIG. 15 is a plan view of a disk for use in connecting a start end and a terminal end of the strand material.

FIG. 16 is a perspective view for explaining a method of connecting the start end and the terminal end of the strand material.

FIG. 17 is a perspective view of a connected overlap portion of the strand material after the connection.

FIG. 18 is a perspective view showing an endless metal belt according to the embodiment in a state during use.

FIG. 19 is a sectional view showing another example of the annular metal cord.

### REFERENCE NUMERALS

1 . . . strand material, 1a . . . start end (end), 1b . . . terminal end (end), 3 . . . annular core portion, 4 . . . outer layer portion, 5 . . . metal filament, 7, 7a . . . connecting member, 7b . . . connected overlap portion, 71 . . . disk (plate member), 73 . . . insertion hole (holding element), 74 . . . slit (holding element), B1 . . . endless metal belt, and C1 . . . annular metal cord.

### BEST MODE FOR CARRYING OUT THE INVENTION

A preferred embodiment of the present invention will be described in detail below with reference to the accompanying drawings. It is to be noted that identical components or components having identical functions are denoted by the same reference numerals in the following description, and a duplicate description of those components is omitted.

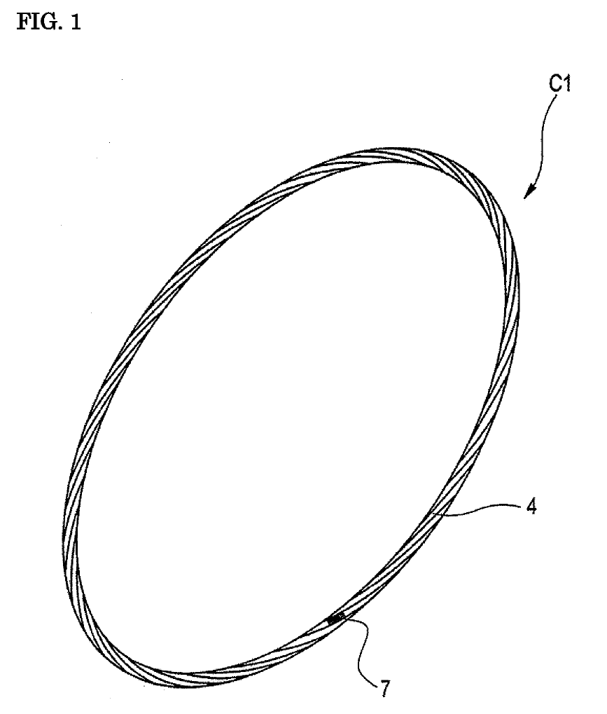

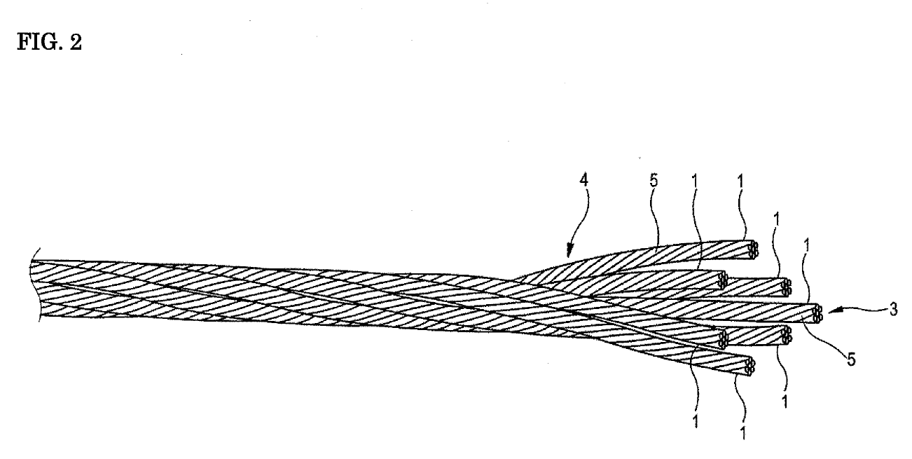

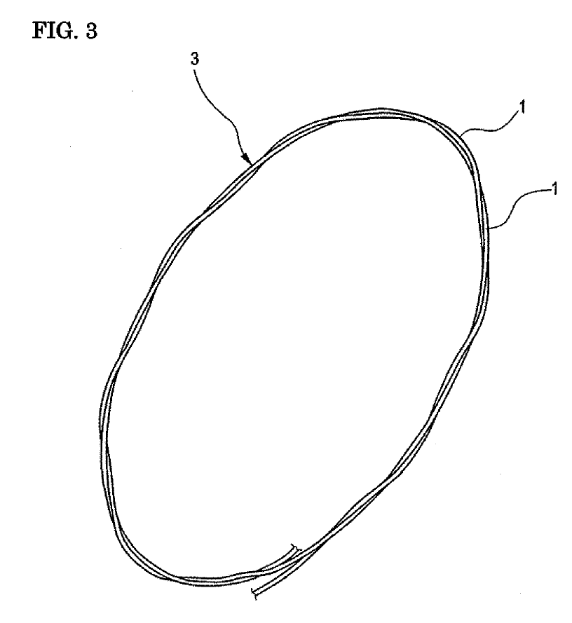

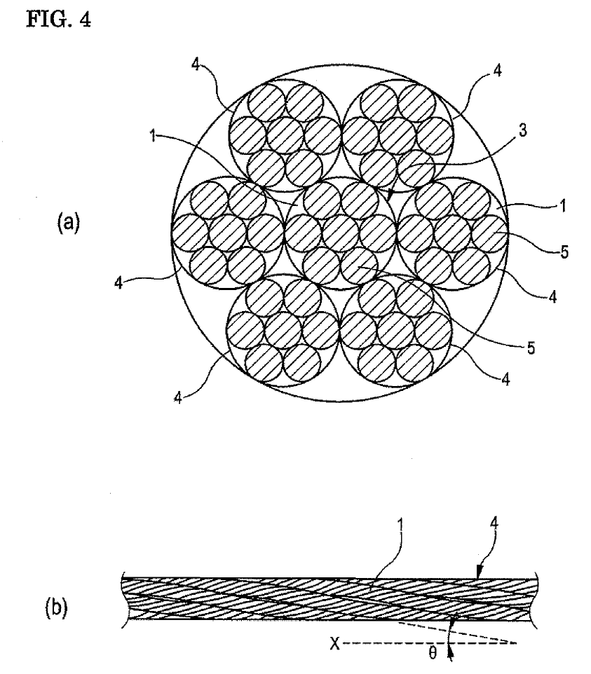

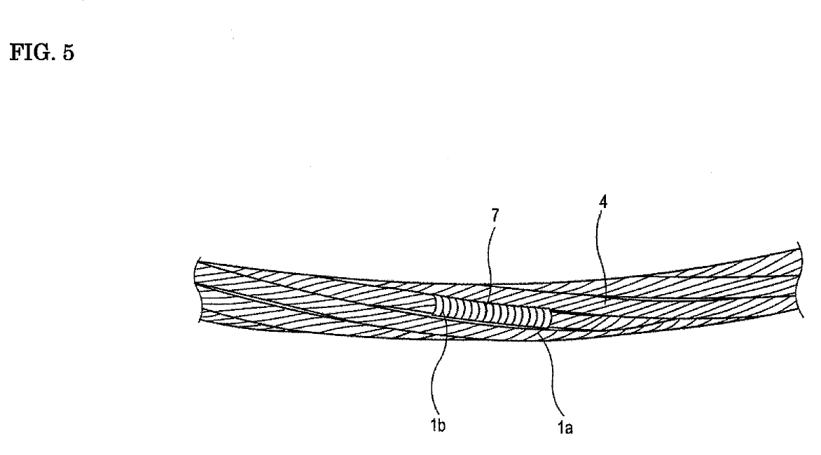

An annular metal cord according to the embodiment will be described with reference to the drawings. FIG. 1 is a perspective view of an annular metal cord according to the embodiment, and FIG. 2 is a perspective view showing the annular metal cord, radially sectioned, according to the embodiment. FIG. 3 is a perspective view showing a state where a strand material is wound around an annular core portion while running over its annular circumference once, which is included in the annular metal cord according to the embodiment. FIG. 4(a) is a radial sectional view showing the annular metal cord according to the embodiment, and FIG. 4(b) is a side view of the annular metal cord according to the embodiment. FIG. 5 is an enlarged perspective view showing part of the annular metal cord according to the embodiment.

As shown in FIGS. 1 and 2, the annular metal cord C1 includes an annular core portion 3 and an outer layer portion 4 covering an outer peripheral surface of the annular core portion 3.

The annular core portion 3 is formed, as shown in FIG. 3, by bending (looping) a strand material 1 to make a round, i.e., into an annular shape, with a predetermined radius. The outer layer portion 4 surrounding the annular core portion 3 is formed by continuously winding the strand material 1, which constitutes the annular core portion 3, around the annular core portion 3 with the annular core portion 3 serving as an axial core.

As shown in FIG. 4(a), the strand material 1 is formed by intertwisting a plurality of metal filaments 5. In this embodiment, as illustrated in FIG. 2, the strand material 1 is constituted such that one of the metal filaments 5 is situated at a center and other six strand filaments 5 are wound in S-twist around an outer peripheral surface of the metal filament 5 at the center. Thus, since the strand material 1 is in the geometrically stable form made up of seven intertwisted filaments, it is sturdy and is hard to break.

Each of the metal filaments 5 is made of high-carbon steel containing 0.60 mass % or more of C. By selecting a material containing 0.60 mass % or more of C, the metal filament 5 can be obtained as a steel wire having more superior break strength. Note that the material composition of the metal filament 5 is not limited to the above-described one.

The metal filament 5 has a diameter in the range of not smaller than 0.06 mm, but not larger than 0.40 mm. Herein, since the diameter of the metal filament 5 is 0.06 mm or larger, the strand material 1 has sufficient rigidity and the annular core portion 3 can be made less apt to deform. In addition, since the diameter of the metal filament 5 is 0.40 mm or smaller, the rigidity of the strand material 1 can be kept from increasing beyond a proper level and the annular metal cord C1 can be made less apt to cause a fatigue break due to repeatedly applied stresses. The diameter of the metal filament 5 is more preferably in the range of not smaller than 0.06 mm, but not larger than 0.22 mm.

Thus, by using the metal filament 5 having such a diameter to form the strand material 1, the strand material 1 having appropriate rigidity can be obtained. As a result, the strand material 1 can be easily wound around the annular core portion 3 and loosening of the wound strand material 1 is less apt to occur.

The strand material 1 is spirally wound around the annular core portion 3 while running over its annular circumference plural times, as shown in FIGS. 2 and 3. The strand material 1 is wound in a manner causing no torsion. By so winding, loosing of the wound strand material 1 can be suppressed.

In this embodiment, the strand material 1 constituting the outer layer portion 4 is wound along the outer peripheral surface of the annular core portion 3 while running over its annular circumference six times. Since the strand material 1 wound around the annular core portion 3 is constituted by a single strand material 1, which is continuously used in common after forming the annular core portion 3, the strand material 1 can be wound around the outer peripheral surface of the annular core portion 3 with substantially no gaps left. Accordingly, the outer layer portion 4 closely covers the annular core portion 3. The annular metal cord C1 has a cross section that, as shown in FIG. 4(a), six parts of the strand material 1 are arrayed around the strand material 1 serving as the annular core portion 3. The cross-sectional shape of the strand material 1 is the same as that obtained by intertwisting seven strand materials 1. Thus, the annular metal cord C1 has not only a most-densely filling twist structure in cross section, which is advantageous for saving of a space, but also a geometrically stable structure. As a result, the annular metal cord C1 can be made superior in break strength and fatigue resistance, and also endurable against deformations in the radial direction.

As shown in FIG. 3, the strand material 1 constituting the outer layer portion 4 is wound in Z-twist around the outer peripheral surface of the annular core portion 3. Since the strand material 1 is in itself formed by winding the filaments in S-twist, the annular metal cord C1 has a structure including the S-twist and the Z-twist in a mixed state. In other words, since the twisting direction of the metal filament 5 and the winding direction of the outer layer portion 4 with respect to the annular core portion 3 are opposed to each other, the annular metal cord C1 can be obtained which is hard to cause torsion and has less ruggedness in its external appearance.

In addition, the strand material 1 constituting the outer layer portion 4 is wound at a predetermined winding angle with respect to a center axis of the annular core portion 3. Therefore, the strand material 1 can be wound without disorder, and the annular metal cord C1 having a substantially uniform surface state can be obtained. In this embodiment, as shown in FIG. 4(b), a winding angle θ of the strand material 1 with respect to the X-direction, i.e., the direction in which the center axis of the annular core portion 3 extends, is not smaller than 4.5 degrees, but not larger than 13.8 degrees. By setting the winding angle θ to be 4.5 degrees or larger, the loosing of the wound strand material 1 can be made less apt to occur. By setting the winding angle θ to be 13.8 degrees or smaller, the elongation of the strand material 1 can be prevented from increasing excessively. In other words, by setting the winding angle θ of the strand material 1, which is wound around the annular core portion 3 and constitutes the outer layer portion 4, to be not smaller than 4.5 degrees, but not larger than 13.8 degrees, the annular metal cord C1 having appropriate elongation and being pliable can be obtained. When the annular metal cord C1 having such properties is used, for example, in an endless metal belt described later, power transmission between a drive pulley and a driven pulley can be performed with high accuracy.

As shown in FIG. 5, a winding start end 1a and a winding terminal end 1b of the strand material 1 constituting the annular core portion 3 and the outer layer portion 4 are joined together by welding. Further, a joined portion between both the winding ends is covered with a connecting member 7.

The connecting member 7 is constituted by a sleeve which is in the form of a coil spring and has superior flexibility. The connecting member 7 is fixed in place by an adhesive so as to cover an outer periphery of the joined portion between both the ends of the strand material 1, i.e., the start end 1a and the terminal end 1b thereof. The connecting member 7 formed of the coil spring sleeve is pliably deformed in conformity with a curved shape of the strand material 1, thereby protecting and reinforcing the welded portion of the strand material 1.

Thus, by joining together the start end 1a and the terminal end 1b of the strand material 1 by using the connecting member 7 which is formed of the coil spring sleeve and which has superior flexibility, the connecting member 7 can be attached in a state satisfactorily covering the joined portion in conformity with its shape in which the start end 1a of the strand material 1 constituting the annular core portion 3 is joined to the terminal end 1b of the strand material 1 which constitutes the outer layer portion 4 and is inclined relative to the start end 1a. Accordingly, the joined portion between the start end 1a and the terminal end 1b of the strand material 1 can be satisfactorily protected. Further, since the connecting member 7 does not impede deformation of the strand material 1 in the joined portion, flexibility of the strand material 1 can be kept at an even level between the joined portion and the other portion, whereby mechanical characteristics of the annular metal cord C1 can be made substantially uniform over its entire circumference.

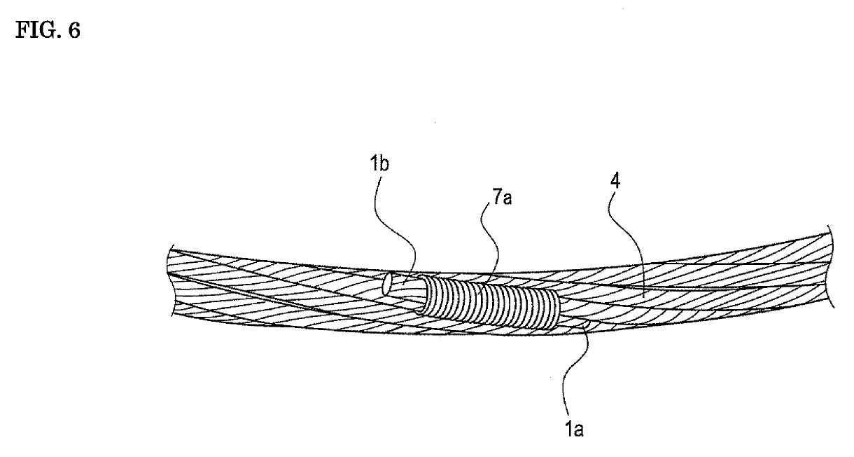

Instead of the structure shown in FIG. 5, the winding start end 1a and the winding terminal end 1b of the strand material 1 constituting the annular core portion 3 and the outer layer portion 4 may be connected together, as shown in FIG. 6, such that the winding ends are held inside a connecting member 7a made of a sleeve in the form of a coil spring while they are overlapped with each other in the axial direction.

More specifically, the connecting member 7a is constituted by a sleeve which is in the form of a coil spring and has superior flexibility. The connecting member 7a has a sleeve inner diameter smaller than twice the diameter of the strand material 1. Since the coil spring sleeve has superior flexibility, the connecting member 7a is pliably deformed in conformity with a curved shape of the spirally wound strand material 1, thereby maintaining a close contact state with the connected portion. Further, the connected portion has a diameter almost equal to that of two strand materials 1 and excessive enlargement of the connected portion is avoided. In other words, mechanical characteristics of the annular metal cord C1 can be made substantially uniform over its entire circumference.

Further, since the connecting member 7a has the sleeve inner diameter smaller than twice the diameter of the strand material 1, a force is generated to act on the connecting member 7a from both the ends of the strand material 1, which are overlapped with each other inside the connecting member 7a, thus enlarging the diameter of the connecting member. Simultaneously, a reaction is generated due to elasticity of the connecting member 7a such that a compressive force acts on both the ends of the strand material 1, which are overlapped with each other inside the connecting member 7a, from the connecting member 7a, thus tightening both the ends of the strand material 1. Therefore, both the ends of the strand material 1 are securely connected together by frictional forces between the connecting member 7a and the strand material 1 and between both the ends of the strand material 1. In addition, even when a tensile force acts on the connected portion, the coil spring sleeve is caused to extend in the axial direction, whereby both the ends of the strand material 1 inside the connecting member are further strongly compressed and tightened. As a result, a stable connected state can be maintained.

While the connecting members 7 and 7a, shown in FIGS. 5 and 6, may have a spacing between adjacent spring wires (i.e., a coil gap), they are each preferably made of a sleeve in the form of a close-wound coil spring having no coil gap. In comparison with a spring having a coil gap, the close-wound coil spring can more securely maintain a force acting to tighten both the ends of the strand material 1 even when the strand material 1 is bent at a smaller radius of curvature. Further, since the number of coil windings per unit length is increased, both the ends of the strand material 1 can be more securely held in a tightened state.

The spring wires constituting each of the connecting members 7 and 7a, shown in FIGS. 5 and 6, preferably have a larger diameter than the metal filaments 5 constituting the strand material 1. In order to tighten both the ends of the strand material 1 for securely connecting them to each other, the spring wires constituting each of the connecting members 7 and 7a are required to have a certain level of strength. When the diameter of the spring wires is relatively larger than that of the metal filaments 5 constituting the strand material 1, the strength of the connecting member can be more easily obtained at a level necessary for maintaining the connected state.

Instead of the structures shown in FIGS. 5 and 6, the winding start end 1a and the winding terminal end 1b of the strand material 1 constituting the annular core portion 3 and the outer layer portion 4 may be connected in a connected overlap portion 7b. In the connected overlap portion 7b, both the ends of the strand material 1 are evenly intertwisted such that they are plastically deformed to be integrated together in the intertwisted portion. Thus, since the winding start end 1a and the winding terminal end 1b of the strand material 1 are intertwisted and plastically deformed in the connected overlap portion 7b for the connection between them, another additional member for establishing the connection is not required and a projection appearing on the cord surface can be minimized. Therefore, the annular metal cord can be suitably used, for example, in a drive transmission belt for an industrial machine.

Further, since the connected overlap portion 7b does not impede deformation of the strand material 1 in the joined portion, flexibility of the strand material 1 can be kept at an even level between the joined portion and the other portion. Hence, mechanical characteristics of the annular metal cord C1 can be made substantially uniform over the entire circumference.

In addition, both the ends of the strand material 1 are intertwisted in the connected overlap portion 7b in the same direction as the twisting direction of the metal filaments 5 in the strand material 1. In the connected overlap portion 7b, therefore, the strand material 1 can be easily plastically deformed at a less number of times of twists without causing untwisting of the metal filaments 5. As a result, both the ends of the strand material 1 can be connected together in a state suppressing a reduction of strength, and a reduction of fatigue strength can also be suppressed.

The number of times of twists in the connected overlap portion 7b is preferably 2-5 in practice. By selecting such a number of times of twists, the winding start end 1a and the winding terminal end 1b of the strand material 1 can be connected together at sufficient strength. In addition, variations in amount of plastic deformation of the strand material due to over-twisting can be reduced to suppress brittleness of the metal filaments 5, and the securely connected state can be maintained.

The connected portions (corresponding to the connecting members 7 and 7a and the connected overlap portion 7b) between the start end 1a and the terminal end 1b, shown in FIG. 5-7, are each located on one of opposite side areas of a circular arc defined by the annular metal cord C1 except for the inner and outer peripheral sides of the circular arc, i.e., at a position substantially intermediate between the inner and outer peripheries of the annular metal cord C1. By thus arranging the connected portion at the position substantially intermediate between the inner and outer peripheries of the annular metal cord C1 where tensile forces and compressive forces act at minimum, even when the annular metal cord C1 is deformed in the radial direction, a load acting on the connected portion can be reduced and a break in the connected portion can be suppressed.

As described above, the annular metal cord C1 is formed by winding the strand material 1, which constitutes the outer layer portion 4, around the strand material 1 which constitutes the annular core portion 3, and then connecting together the start end 1a and the terminal end 1b of the strand material 1 by using one of the connecting members 7 and 7a or forming the connected overlap portion 7b.

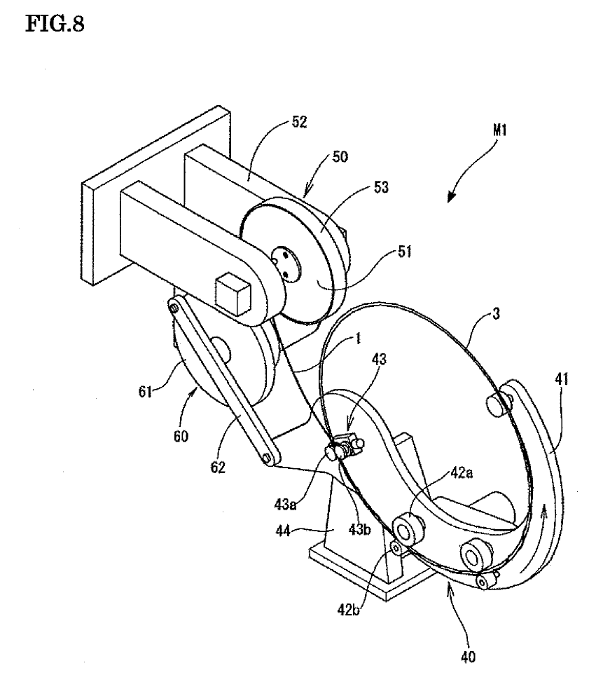

Next, a method of producing the annular metal cord C1 will be described. FIG. 8 is a perspective view showing one example of a production apparatus for producing the annular metal cord C1.

An illustrated production apparatus M1 includes a driving unit 40 for rotating the annular core portion 3 in the circumferential direction, and a supply unit 50 for the strand material 1, which supplies the strand material 1 rolled up around a reel 51 to a winding area of the annular core portion 3.

The supply unit 50 for the strand material 1 is fixed in a predetermined position.

The driving unit 40 is installed on an arc-shaped holding arm 41 and has two pinch rollers 42a and 42b which are coupled to a driving motor and rotate the annular core portion 3 in the circumferential direction.

The holding arm 41 includes a clamping unit 43 which is disposed on its part positioned nearer to the supply side of the strand material 1 in a direction opposed to the rotating direction of the annular core portion 3 and which surrounds the annular core portion 3. The clamping unit 43 comprises two rollers 43a and 43b and serves to prevent a lateral shake of the annular core portion 3, to maintain stable rotation in the circumferential direction, and to properly position a winding point for the strand material 1, thereby ensuring high winding performance. Note that, in the illustrated example, the annular core portion 3 is vertically standing and is rotated in the circumferential direction while suppressing the lateral shake.

Since the clamping unit 43 comprising the two rollers 43a and 43b is just required to have the functions of preventing a lateral shake of the annular core portion 3, surrounding the annular core portion 3 and maintaining stable rotation in the circumferential direction even with the annular metal cord having a final finish diameter, and fixedly positioning the winding point where the strand material 1 starts to be twisted, a groove shape is not limited to particular one and it may be substantially channel- or C-like, arcuate, or V-like.

The holding arm 41 is swingably installed on a stand 44 so as to perform swing motions by a swing mechanism 60, which comprises a rotary disk 61 and a crankshaft 62, with the clamping unit 43 serving as a fulcrum.

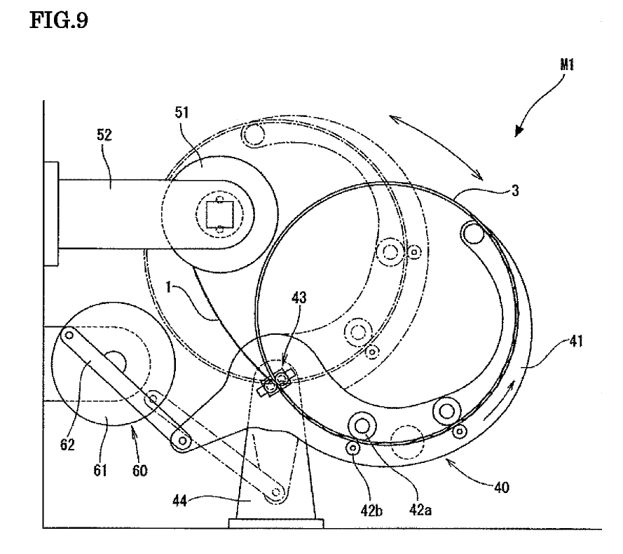

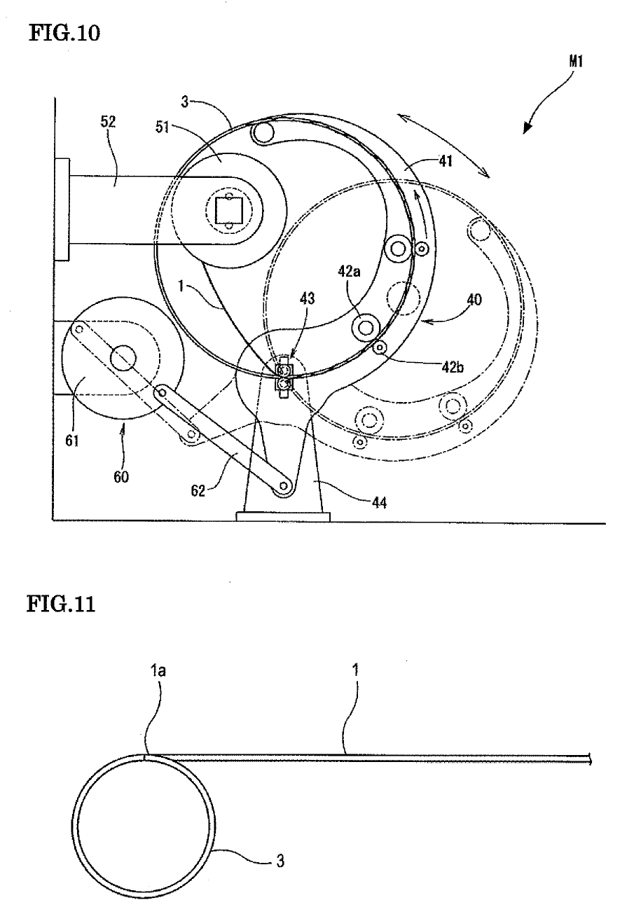

The annular core portion 3 held by the holding arm 41 swings such that the reel 51 is positioned outside a loop of the annular core portion 3 at one end of a cycle of the swing motions as indicated by solid lines in FIG. 9, and that the reel 51 is positioned inside the loop of the annular core portion 3 at the other end of the cycle of the swing motions as indicated by solid lines in FIG. 10.

The supply unit 50 for the strand material 1 includes a pair of front and rear cassette stands 52 which are installed in an opposed relation to extend horizontally at a distance spaced from each other to such an extent as not interfering with the swing motions of the annular core portion 3 held by the holding arm 41. The cassette stands 52 include at their distal ends respective reel transfer mechanisms which are positioned to face each other while a plane including the annular core portion 3 is interposed between both the mechanisms.

The supply unit 50 comprises the reel 51 around which the strand material 1 is rolled up, and a cassette 53 having a diameter slightly larger than an outer diameter of the reel 51 and having a cylindrical outer peripheral wall of which width corresponds to at least a reel inner width. The reel 51 is rotatably accommodated within the cassette 53 in a state that an entire surface of the rolled strand material 1 is covered, thus constituting a so-called cartridge. A reel-out hole is formed in the outer peripheral wall of the cassette 53, and the strand material 1 is led out through the reel-out hole toward the clamping unit 43 which is located at the winding point for the annular core portion 3. The strand material 1 is rolled up around the reel 51 at a pre-adjusted coil diameter and is set within the cassette 53 of the supply unit 50.

The pair of cassette stands 52 include, at their distal ends in opposed positions, guide rods to which the cassette 53 is detachably attached, and transfer mechanisms for transferring the cassette 53, which is attached to one of the guide rods, to the other guide rod. The transfer mechanisms are capable of transferring the cassette 53, which is attached to one of the guide rods, to the other guide rod by extending and retracting the guide rods by air cylinders such that one extended rod pushes a central portion of the cassette 53.

When using the production apparatus M1 constructed as described above, the annular metal cord C1 is produced through the following steps.

As shown in FIG. 11, a single strand material 1 is bent (looped) in its start end side into an annular shape, thus forming the annular core portion 3.

Next, overlapped two parts of the strand material 1 near the start end 1a thereof are temporarily fixed together by winding an adhesive tape, a string, a spring or the like.

After the temporary fixing, the annular core portion 3 is set on the driving unit 40 of the production apparatus M1. The annular core portion 3 is then rotated in the circumferential direction to start winding of the strand material 1 around the annular core portion 3.

In the case of the winding in Z-twist with rotation of the annular core portion 3 in the circumferential direction, from a state where the reel 51 including the strand material 1 rolled up thereon is positioned on the left side with respect to the plane including the annular core portion 3 and the reel 51 is positioned outside the loop of the annular core portion 3 as indicated by the solid lines in FIG. 9, the annular core portion 3 is swung about the clamping unit 43 as a fulcrum to a position where the reel 51 comes into the inside of the loop of the annular core portion 3 as indicated by the solid lines in FIG. 10. Further, the reel 51 is moved perpendicularly to the plane including the annular core portion 3 by operating the air cylinder, which is disposed at the distal end of one cassette stand 52, for transfer of the cassette 53 to the guide rod of the other cassette stand 52, whereby half-turn winding of the strand material 1 is performed. Then, from the state where the reel 51 is positioned inside the loop of the annular core portion 3 as indicated by the solid lines in FIG. 10, the annular core portion 3 is swung about the clamping unit 43 as a fulcrum to the position where the reel 51 comes out of the inside of the loop of the annular core portion 3 as indicated by the solid lines in FIG. 9. Further, the reel 51 is moved, along with the cassette 53, perpendicularly to the annular core plane again by operating the air cylinder in the outer side of the loop of the annular core portion 3, whereby one-turn winding of the strand material 1 is completed. By repeating the above-described operation, the strand material 1 constituting the outer layer portion 4 is spirally wound around the outer peripheral surface of the annular core portion 3.

Since the reel 51 reciprocally crosses the core plane of the annular core portion 3 at a predetermined position and the annular core portion 3 repeats swing motions about the clamping unit 43 as a fulcrum, which provides the winding point for the strand material 1, the distance from the reel 51 to the winding point for the strand material 1 is kept substantially constant. In the winding step, therefore, the strand material 1 led out from the reel 51 can be avoided from loosening and the strand material 1 can be wound around the annular core portion 3 under constant tension.

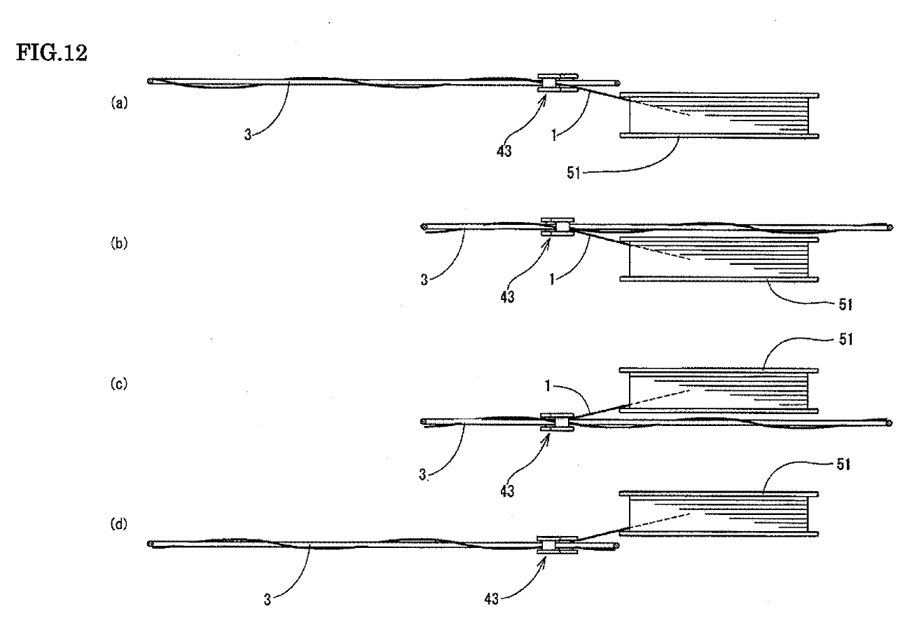

FIG. 12 shows the locus along which the reel 51 including the strand material 1 rolled up thereon is moved, and the locus along which the annular core portion 3 repeats the swing motions.

More specifically, the following cycles are repeated. From a state where the reel 51 is positioned outside the annular core portion 3 as shown in FIG. 12(a), the annular core portion 3 is swung to a state where the reel 51 is positioned inside the loop of the annular core portion 3 as shown in FIG. 12(b). At the position shown in FIG. 12(b), the reel 51 is transferred from one side of the annular core portion 3 to the opposite side as shown in FIG. 12(c). Then, in the state where the reel 51 is positioned on the opposite side of the annular core portion 3, the annular core portion 3 is swung from a position shown in FIG. 12(c) to a state where the reel 51 is positioned outside the loop of the annular core portion 3 as shown in FIG. 12(d). Then, the reel 51 is returned from the opposite side of the annular core portion 3 to the start position (i.e., the position shown in FIG. 12(a)) on the original one side of the annular core portion 3. Thus, in this embodiment, the strand material 1 is spirally wound around the annular core portion 3 by swinging the annular core portion 3 with respect to the reel 51 as represented by (a)→(b)→(c)→(d)→(a) in FIG. 12 and by moving the reel 51 perpendicularly to the core plane of the annular core portion 3 as represented by (b)→(c) and (d)→(a) in FIG. 12.

The structure of the connected portion shown in FIG. 5 can be obtained as follows. After completion of the winding of the strand material 1, the winding terminal end 1b of the strand material 1 is inserted through the connecting member 7 and the temporary fixing near the start end 1a is released. The start end 1a and the terminal end 1b are then joined together by welding. Subsequently, an adhesive is applied to the joined portion between the start end 1a and the terminal end 1b, and the connecting member 7 is slid to a position where it covers the joined portion. Thus, the connecting member 7 is fixed to the joined portion by the adhesive as shown in FIG. 5. As a result, the joined portion is protected by the connecting member 7 and a break at the joined point can be suppressed.

The structure of the connected portion shown in FIG. 6 can be obtained as follows. After completion of the winding of the strand material 1, the temporary fixing near the start end 1a of the strand material 1 is released. The start end 1a and the terminal end 1b are then put inside the connecting member 7a and connected together in such a state that both the ends are overlapped with each other in the axial direction.

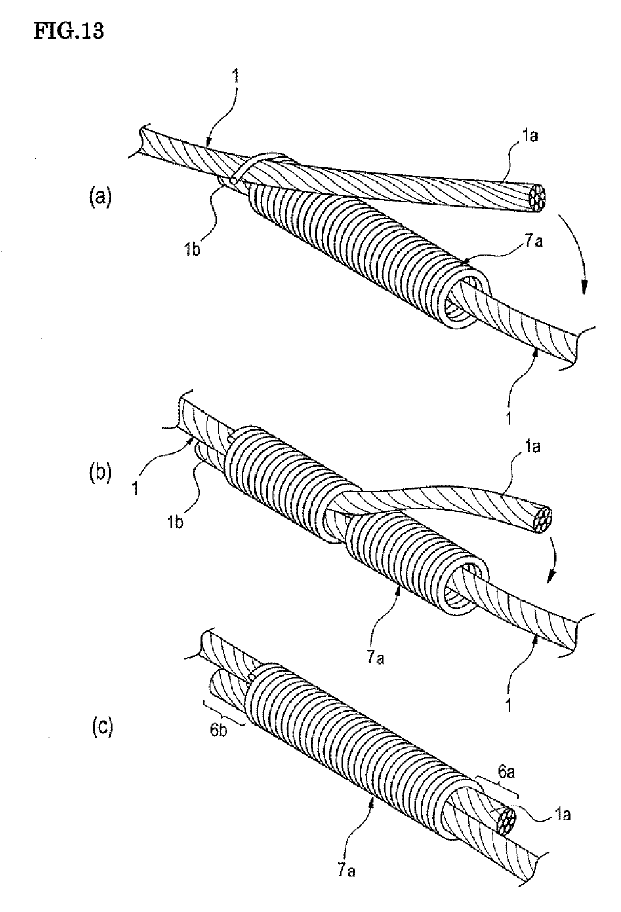

To hold the start end 1a and the terminal end 1b inside the connecting member 7a, as shown in FIG. 13(a), the terminal end 1b of the strand material 1 is first inserted into the connecting member 7a from its one end (located in the front right side as viewed on the drawing) and passed through the inside of the connecting member 7a until the inserted leading end of the strand material 1 is exposed from the other end (located in the rear left side as viewed on the drawing) of the connecting member 7a. Further, a spring wire of the connecting member 7a, which is located at the other end (located in the rear left side as viewed on the drawing) thereof is moved away from an adjacent spring wire to widen the coil gap between them, and the start end 1a of the strand material 1 is inserted into the widened coil gap. A length of the strand material 1 inserted at that time is set to be longer than the length of the connecting member 7a. Contrary to the description, the start end 1a may be first inserted into the connecting member 7a and the terminal end 1b may be then inserted into the coil gap.

Next, as shown in FIG. 13(a), the start end 1a inserted into the coil gap is turned around the connecting member 7a in a direction indicated by arrow such that it is moved along the coil gap toward the end of the connecting member 7a on the side opposed to the side from which the start end 1a has been inserted. As a result, a portion of the start end 1a farther away from the end face comes into a state inserted within the end of the connecting member 7a, and a portion of the start end 1a nearer to the end face comes into a state projecting externally of the connecting member 7a through the coil gap. Thus, the start end 1a is gradually put into the inside of the connecting member 7a from the portion of the start end 1a further away from the end face. In parallel, inside the connecting member 7a, the portion of the start end 1a further away from the end face is gradually overlapped with the terminal end 1b which has been already inserted.

Then, as shown in FIG. 13(b), when the start end 1a is turned around the connecting member 7a to move up to a position corresponding to half the number of coil windings of the connecting member 7a, it comes into a state that the portion of the start end 1a nearer to the end face projects out from the coil gap at a middle position of the connecting member 7a. By further turning the start end 1a to move along the coil gap, the start end 1a is gradually put into the inside of the connecting member 7a from the middle position thereof toward the end of the connecting member 7a while the start end 1a and the terminal end 1b are overlapped with each other.

When the start end 1a is further turned to move along the coil gap until reaching the end of the connecting member 7a on the side opposed to the side from which the start end 1a has been inserted into the coil gap, as shown in FIG. 13(c), the start end 1a and the terminal end 1b are put inside the connecting member 7a over its entire length in such a state that both the ends are overlapped with each other in the axial direction. Hence, the start end 1a and the terminal end 1b are securely connected together by the compressive force of the connecting member 7a.

Thereafter, extra end extensions 6a and 6b of the start end and the terminal end, which are exposed outside the connecting member 7a, are cut and removed. As a result, both the ends of the strand material 1 in the connected portion are held inside the connecting member 7a such that the connected portion also has a similar shape to that of the other portion of the annular metal cord C1, thereby providing a substantially uniform structure in the annual direction.

Thus, according to the connecting method of this embodiment which comprises the steps of inserting one end of the strand material 1 into the connecting member 7a, inserting the other end of the strand material 1 into the coil gap between the spring wires at one end of the connecting member 7a, and moving the other end of the strand material 1 up to the other end of the connecting member 7a on the side opposed to the side from which the other end of the strand material 1 has been inserted, the start end 1a and the terminal end 1b of the strand material 1 can be easily put inside the connecting member 7a in an overlapped state, which has the sleeve inner diameter smaller than twice the diameter of the strand material 1.

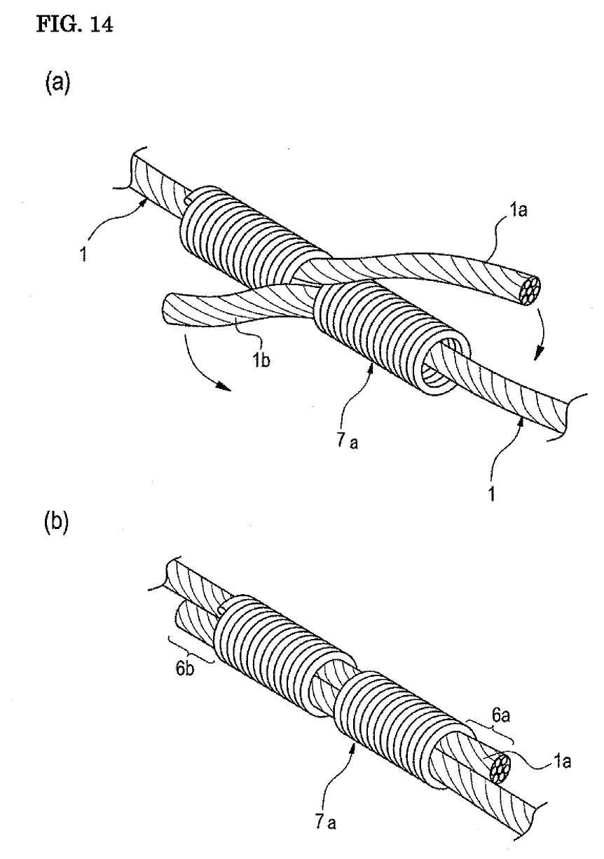

Another method for putting the start end 1a and the terminal end 1b inside the connecting member 7a and connecting them together will be described with reference to FIG. 14.

First, as shown in FIG. 14(a), the start end 1a of the strand material 1 is inserted into the connecting member 7a from its one end (located in the rear left side as viewed on the drawing) up to an axial intermediate portion of the connecting member 7a. Then, the start end 1a of the strand material 1, which is now inside the connecting member 7a, is drawn out externally of the connecting member 7a, as shown in FIG. 14(a), through a coil gap between adjacent spring wires in the axial intermediate portion of the connecting member 7a. At that time, the start end 1a is drawn out so as to have a sufficient extra end extension.

As with the start end 1a, the terminal end 1b of the strand material 1 is inserted into the connecting member 7a from the other end (located in the front right side as viewed on the drawing) up to the axial intermediate portion of the connecting member 7a. Then, the terminal end 1b of the strand material 1, which is now inside the connecting member 7a, is drawn out externally of the connecting member 7a, as shown in FIG. 14(a), through the same coil gap as that from which the start end 1a has been drawn out. At that time, the terminal end 1b is also drawn out so as to have a sufficient extra end extension. The axial intermediate portion of the connecting member 7a through which the start end 1a and the terminal end 1b are drawn out is preferably formed to have a previously widened coil gap (e.g., 1.5-4.5 times the diameter of the strand material 1) for facilitating the drawing operation.

Thereafter, the start end 1a and the terminal end 1b both inserted into the coil gap are turned around the connecting member 7a in directions indicated by respective arrows such that each end is moved along the coil gap toward the end of the connecting member 7a on the side opposed to the side from which the relevant end has been inserted. As a result, the start end 1a and the terminal end 1b are gradually put into the inside of the connecting member 7a in an overlapped state from a middle position of the connecting member 7a toward the opposite ends thereof.

When the start end 1a and the terminal end 1b are each further turned to move along the coil gap until reaching the end of the connecting member 7a on the side opposed to the side from which the relevant end has been inserted into the connecting member 7a, as shown in FIG. 14(b), the start end 1a and the terminal end 1b are put inside the connecting member 7a over its entire length in such a state that both the ends are overlapped with each other in the axial direction. Hence, the start end 1a and the terminal end 1b are securely connected together by the compressive force of the connecting member 7a. Thereafter, the extra end extensions 6a and 6b of the start end and the terminal end, which are exposed outside the connecting member 7a, are cut and removed. As a result, both the ends of the strand material 1 in the connected portion are held inside the connecting member 7a such that the connected portion also has a similar shape to that of the other portion of the annular metal cord C1, thereby providing a substantially uniform structure in the annual direction.

Thus, according to the modified connecting method, shown in FIG. 14, which comprises the steps of inserting respectively the start end 1a and the terminal end 1b of the strand material 1 into the connecting member 7a from the opposite sides of the connecting member 7a, drawing out both the inserted ends of the strand material 1 through the coil gap between the spring wires in the axial intermediate portion of the connecting member 7a, and moving each of the inserted ends of the strand material 1 up to the end of the connecting member 7a on the side opposed to the side from which the relevant end of the strand material 1 has been inserted, the start end 1a and the terminal end 1b of the strand material 1 can be easily put inside the connecting member 7a in an overlapped state, which has the sleeve inner diameter smaller than twice the diameter of the strand material 1.

When forming the connected portion in the structure of FIG. 5 or 6, the terminal end of the strand material 1 nearer to the outer peripheral layer 4 is inclined relative to the start end 1a nearer to the annular core portion 3, thereby causing slight bending of the joined portion. However, since the connecting members 7 and 7a are each formed of the coil spring sleeve and has superior flexibility, the connecting members 7 and 7a can be easily fitted over the joined portion.

By winding the strand material 1 around the annular core portion 3 and joining together the start end 1a and the terminal end 1b thereof as described above, the outer layer portion 4 can be formed around the annular core portion 3.

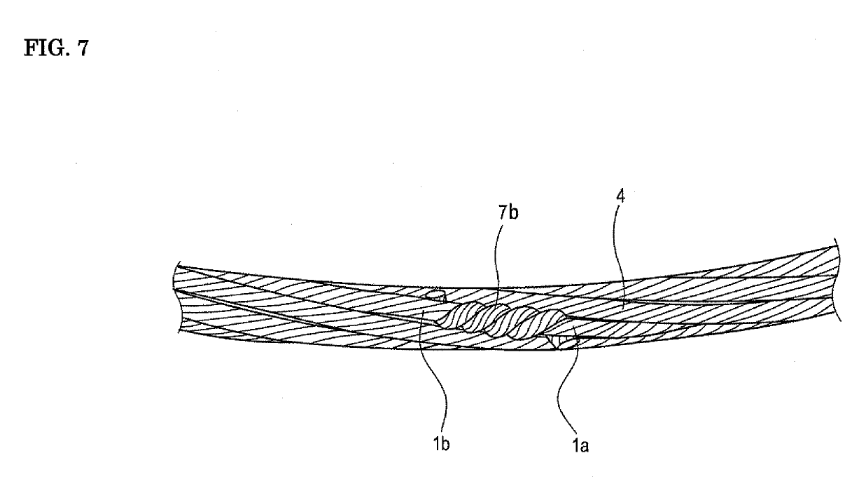

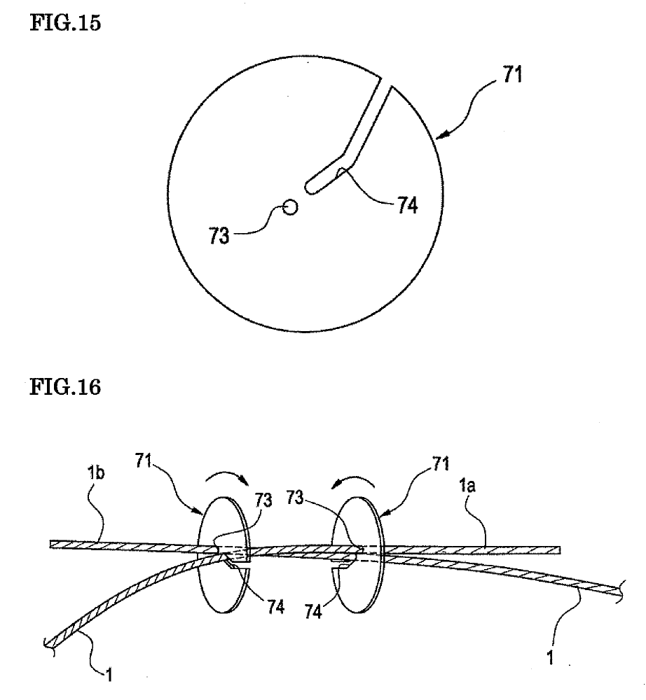

To form the connected portion in the structure of FIG. 7, the start end 1a and the terminal end 1b of the strand material 1 are connected together by using two disks (plate members) 71 shown in FIG. 15.

The disk 71 has an insertion hole 73 which is formed in an eccentric position near a disk center and has a slightly larger diameter than the strand material 1 such that the strand material 1 can be inserted through the insertion hole 73. Also, the disk 71 has a slit 74 which is formed to be opened at an outer periphery of the disk and to extend until the center of the disk 71. In other words, a bottom portion of the slit 74 is located at a center position of the disk 71. Since the slit 74 has a width slightly larger than the diameter of the strand material 1, the strand material 1 can be inserted into the slit 74 from its end opened at the outer periphery of the disk 71. Further, since the slit 74 is formed such that the extending direction of the slit 74 is bent near its bottom portion, the strand material 1 arranged near the bottom portion of the slit 74 is hard to move outward in the radial direction. Thus, the strand material 1 can be relatively easily held at the bottom portion of the slit 74.

When connecting together the start end 1a and the terminal end 1b of the strand material 1 by using the disk 71 described above, as shown in FIG. 16, the start end 1a and the terminal end 1b of the strand material 1 to be connected together are each inserted into the respective slits 74 in one of two disks 71 which are arranged in parallel with a certain interval left between them. Further, the start end 1a and the terminal end 1b are each passed through the insertion hole 73 of the other disk 71 located oppositely to the one disk 71 and is extended to the outside through a predetermined size such that a twisting margin at each end of the strand material 1 has a larger size than the interval between the two disks 71, which defines the length of the connected overlap portion 7b.

On that occasion, a plurality of pins or small-diameter rollers are attached to or engaged with connection non-target portions of the strand material 1 other than connection target portions thereof which are to be connected together. Those pins or the small-diameter rollers, i.e., catching members, are then moved in a direction away from the connection non-target portions of the strand material 1 such that plural parts of the strand material 1 constituting the connection non-target portions are spaced from the connection target portions thereof.

In such a state, the disks 71 are rotated in opposed directions. As a result, both the ends of the strand material 1 passing through the insertion holes 73 and the slits 74 of the disks 71 while being bound thereto are intertwisted between the disks 71.

After intertwisting both the ends of the strand material 1 a predetermined number of times, the rotation of the disks 71 is stopped and the disks 71 are moved in directions away from each other to draw out the start end 1a and the terminal end 1b of the strand material 1 through the respective insertion holes 73 of the corresponding disks 71. Further, the disks 71 are removed from the strand material 1 by drawing out both the ends of the strand material 1 through the respective slits 74 of the corresponding disks 71.

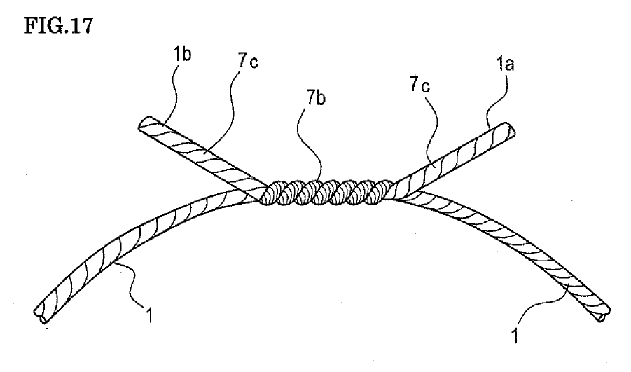

Then, not-twisted extra extensions 7c of the strand material 1, which are extended out as parts of the twisting margins from the connected overlap portion 7b as shown in FIG. 17, are cut and removed by using, e.g., a cutter.

Consequently, as shown in FIG. 7, the start end 1a and the terminal end 1b of the strand material 1 in the form of a metal wire are evenly intertwisted in the connected overlap portion 7b and are plastically deformed to be integrated together therein for secure connection between them.

By connecting together both the ends of the strand material 1 as described above, both the ends of the strand material 1 can be easily and securely connected together at a low cost by evenly intertwisting and plastically deforming, between the disks 71, both the ends in the connected overlap portion 7b for the secure connection.

Further, since each disk 71 has the insertion hole 73 and the slit 74 which serve as holding elements for the strand material 1, the strand material 1 can be easily held on the disk 71 by inserting the strand material 1 into the slit 74 serving as the holding element. In addition, with the strand material 1 inserted through and held by the insertion hole 73 the strand material 1 can be certainly held at its outer periphery against an inner edge of the insertion hole 73 when both the ends of the strand material 1 are intertwisted, thus resulting in evener intertwisting.

Moreover, since both the ends of the strand material 1 are connected together by using one pair of disks 71, the equipment cost can be considerably reduced.

By winding the strand material 1 around the annular core portion 3 and joining together the start end 1a and the terminal end 1b of the strand material 1 as described above, the outer layer portion 4 can be formed around the annular core portion 3.

After Joining together the start end 1a and the terminal end 1b in any of the structures shown in FIGS. 5-7, the annular core portion 3 and the outer layer portion 4 are preferably subjected to a low-temperature annealing process. More specifically, heat treatment is performed on the annular core portion 3 and the outer layer portion 4 in a pressure chamber which is under vacuum or is supplied with argon in a depressurized atmosphere. Temperature in the heat treatment is set to 70° C.-380° C. With the annealing process, internal strains of the metal filament 5 can be removed and the annular metal cord C1 free from strains can be obtained. When the annular metal cord C1 thus produced is used, for example, in an endless metal belt of a continuously variable transmission described later, the endless metal belt can be obtained which is rotated without meandering. The endless metal belt capable of rotating without meandering causes no wears resulting from contact with surrounding parts, and therefore it can maintain high performance over a long term.

Incidentally, it is more preferable that the low-temperature annealing process be performed before the adhesive for bonding of the connecting member 7 is applied to the joined portion between the start end 1a and the terminal end 1b.

According to this embodiment, as described above, the strand material 1 formed by intertwisting seven metal filaments 5 is used itself as the annular core portion 3 and is spirally wound around the annular core portion 3 while running over its annular circumference plural times, thereby forming the outer layer portion 4 to cover the outer peripheral surface of the annular core portion 3. Thus, since the annular core portion 3 and the outer layer portion 4 are both formed by the continuous strand material 1, the annular metal cord C1 can be made sturdy and a possibility that the annular metal cord C1 is completely broken can be avoided in contrast to the related art in which a plurality of strand materials are joined respectively at their both ends at one concentrated location in the circumferential direction. Stated another way, since the annular core portion 3 is formed by using the strand material 1 as it is and the strand material 1 is continuously wound around the annular core portion 3 serving as an axial core, the annular metal cord having high break strength can be obtained. Further, since external forces applied to the annular metal cord C1 can be borne by the annular core portion 3 and the outer layer portion 4 which are continuous in the form of one strand material, the applied external forces can be dispersed over the entire annular metal cord C1 so as to avoid local concentration of load.

Moreover, when forming the outer layer portion 4, the strand material 1 constituting the annular core portion 3 is continuously wound around the annular core portion 3 while running over its annular circumference six times instead of winding a plurality of strand materials 1. Hence, a single strand material 1 is just required. In comparison with the case using a plurality of strand materials 1, therefore, the number of points at which the strand materials are joined respectively at their both ends can be reduced, whereby a reduction of break strength of the annular metal cord C1 can be suppressed and production thereof can be facilitated. Further, since the strand material 1 constituting the outer layer portion 4 is wound at the predetermined winding angle, the winding of the strand material 1 can be performed free from disorder and the annular metal cord C1 having a substantially uniform surface state can be obtained. The annular metal cord C1 having such a surface state is evenly subjected to externally applied forces, whereby a reduction of the break strength can be further suppressed.

The metal filament 5 has a diameter of not smaller than 0.06 mm, but not larger than 0.40 mm, or not smaller than 0.06 mm, but not larger than 0.22 mm. By so setting, the strand material 1 can be made to have appropriate rigidity and improved fatigue resistance.

Further, the annular core portion 3 and the outer layer portion 4 are formed by using the continuous single strand material 1. Therefore, the strand material 1 constituting the outer layer portion 4 can be wound along the outer peripheral surface of the annular core portion 3 without substantially leaving gaps.

The strand material 1 is formed by winding the metal filaments 5 in the S-twist, whereas the strand material 1 constituting the outer layer portion 4 is wound around the annular core portion 3 in the Z-twist. With such a winding structure, the annular metal cord C1 can be obtained which has less ruggedness in its external appearance, is hard to cause torsion, and makes the strand material 1 wound around the annular core portion 3 and constituting the outer layer portion 4 less apt to loosen after the winding.

The winding angle θ of the strand material 1 with respect to the center axis of the annular core portion 3 is set to be not smaller than 4.5 degrees, but not larger than 13.8 degrees. By so setting, the operation for winding the strand material is facilitated. Further, the annular metal cord C1 having appropriate elongation and causing no loosening of the wound strand material 1 can be obtained.

The strand material 1 constituting the outer layer portion 4 is wound along the outer peripheral surface of the annular core portion 3 while running over its annular circumference six times. Therefore, the outer layer portion 4 closely covers the annular core portion 3, and the annular metal cord C1 has a geometrically stable structure. As a result, the annular metal cord C1 can be reliably obtained which has superior break strength and fatigue resistance and which is durable against deformations in the radial direction.

The annular core portion 3 and the outer layer portion 4 are subjected to the low-temperature annealing process. Therefore, internal strains of the metal filament 5 can be removed. By using the metal filament 5 from which internal strains have been removed, the annular metal cord C1 being harder to break can be reliably obtained.

In the structure of FIG. 5, the start end 1a and the terminal end 1b of the strand material 1 are joined together by using the connecting member 7, and the joined portion is protected by the connecting member 7. In that case, the joined portion of the strand material 1 is harder to break. Further, since the connecting member 7 is formed of the coil spring sleeve, the connecting member 7 can be more easily fitted and the operation for joining together the start end 1a and the terminal end 1b of the strand material 1 is facilitated.

In the structure of FIG. 6, both the ends of the strand material 1 are connected together in a state that they are overlapped with each other in the axial direction and are held inside the connecting member 7a formed of the coil spring sleeve. Therefore, both the ends of the strand material 1 can be easily joined together. Further, since the coil spring sleeve has satisfactory flexibility, it is pliably deformed in conformity with a curved shape of the spirally wound strand material 1 so as to maintain close contact with the connected portion. In other words, the connecting member 7a does not impede deformation of the strand material 1 in the connected portion. Hence, mechanical characteristics of the annular metal cord C1 can be made substantially uniform over the entire circumference. In addition, since the connecting member 7a has the sleeve inner diameter smaller than twice the diameter of the strand material 1, a compressive force is generated to act, from the connecting member 7a, on both the overlapped ends of the strand material 1, thereby ensuring the secure connection. Also, even when a tensile force acts on the connected portion, the coil spring sleeve is caused to extend in the axial direction, whereby both the ends of the strand material 1 are further strongly compressed and tightened. As a result, a stable connected state can be maintained.

In the structure of FIG. 7, both the ends of the strand material 1 are connected together in such a state that they are intertwisted to be plastically deformed in the connected overlap portion 7b. Therefore, another additional member for establishing the connection is not required and a projection appearing on the cord surface can be minimized. Accordingly, the annular metal cord can be suitably used, for example, in a drive transmission belt for an industrial machine.

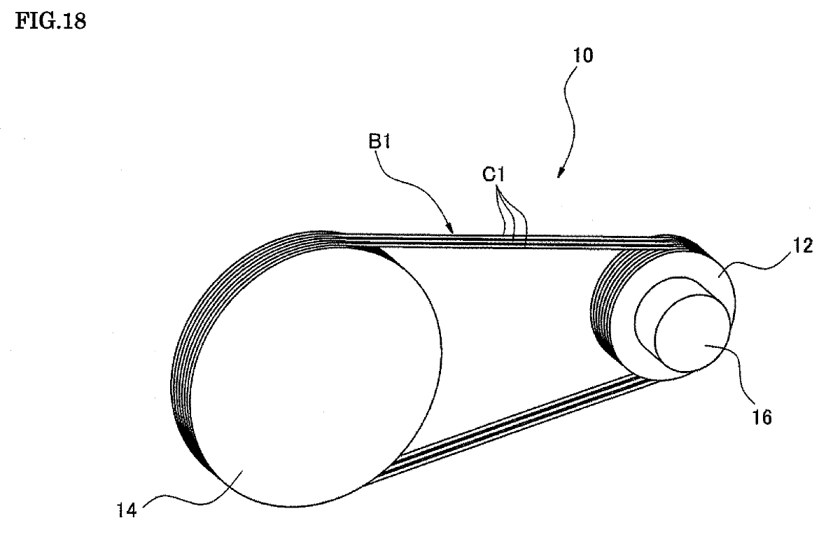

One example of an endless metal belt equipped with the annular metal cord C1 thus construction will be described below. FIG. 18 is a schematic perspective view showing the endless metal belt according to this embodiment in a state during use.

An endless metal belt B1 is employed in a speed reducer 10 shown in FIG. 18, by way of example, which is use in precision machines and industrial machines. The endless metal belt B1 includes three annular metal cords C1 arranged in parallel and performs power transmission between a smaller-diameter drive pulley 12 and a larger-diameter driven pulley 14. A drive shaft of a driving motor 16 is connected to a rotation center of the drive pulley 12. Each of the drive pulley 12 and the driven pulley 14 has a circumferential groove formed in its outer periphery for stable stretching of each annular metal cord C1 between both the pulleys. With the endless metal belt B1 stretching between the drive pulley 12 and the driven pulley 14, a rotational force of the drive pulley 12 is transmitted to the driven pulley 14 through the endless metal belt B1. At that time, a rotational speed of the drive pulley 12 is reduced by the driven pulley 14 so that torque of the drive pulley 12 is increased by the driven pulley 14. The driven pulley 14 is connected, for example, to a shaft of another pulley (not shown) for further transmission of power.

The annular metal cord C1 has, as described above, very high break strength. Also, since the annular metal cord C1 has a substantially circular cross section, it is more durable against torsion than a cord having a rectangular cross section. In comparison with the case using a flat belt as the endless metal belt, therefore, the endless metal belt B1 constituted by using a plurality of annular metal cords C1 has very superior bending resistance and durability.

Note that the present invention is not limited to the above-described embodiment and it can be modified in various ways.

For example, when forming the annular core portion 3, the strand material 1 may be temporarily fixed in the overlapped portion, while leaving an extra extension of the strand material 1 at one end side, such that part of the outer layer portion 4 is constituted by the extra extension of the strand material 1.

As another example, although in the annular metal cord C1 of this embodiment the strand material 1 is wound along the outer peripheral surface of the annular core portion 3 to form the outer layer portion 4 while running over its annular circumference six times, the strand material 1 may be would while running over the annular circumference five times.

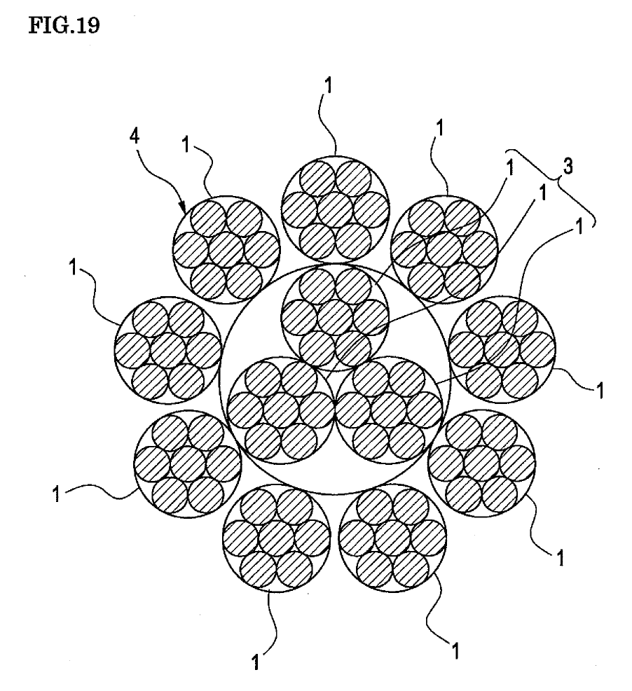

Alternatively, as shown in FIG. 19, the annular metal cord may be formed by bending the strand material 1 to make a round, i.e., to form one loop, continuously winding the strand material 1 to run round the loop twice, thus forming an annular core portion 3 made up of three turns of the strand material 1, and further winding the strand material 1 to run round the loop seven to nine times. The construction shown in FIG. 19 also enables the annular metal cord to have a geometrically stable structure because the outer layer portion 4 closely covers the annular core portion 3.

In the construction shown in FIG. 19, the strand material 1 constituting the outer layer portion 4 is preferably wound in a direction opposed to the winding direction of the annular core portion 3. However, even when the strand material 1 is wound in the same direction in both the annular core portion 3 and the outer layer portion 4, the strand material 1 constituting the outer layer portion 4 can be prevented from falling into between adjacent twist turns of the strand material 1 constituting the annular core portion 3 by setting the winding pitch of the annular core portion 3 to be small and the winding pitch of the outer layer portion 4 to be large (namely, by setting a large difference in the winding pitch between the annular core portion 3 and the outer layer portion 4).

In the annular metal cord C1 of this embodiment, as shown in FIG. 4(a), one layer of the strand material 1 covers the outer peripheral surface of the annular core portion 3. As an alternative, the outer peripheral surface of the annular core portion 3 may be covered with plural layers of the strand material 1. For example, when the outer peripheral surface of the annular core portion 3 is covered with two layers of the strand material 1, a first layer is formed by winding the strand material 1 around the outer peripheral surface of the annular core portion 3 while running over its annular circumference six times, and then a second layer is formed by winding the strand material 1 around an outer peripheral surface of the first layer while running over its annular circumference twelve times. While the direction of the 12-round winding to form the second layer is preferably opposed to the direction of the 6-round winding to form the first layer, those winding directions may be the same if the difference in the winding pitch between the first layer and the second layer is set to be large. Properly setting the winding direction and pitch in such a manner is important from the viewpoints of obtaining a satisfactory winding characteristic and providing an external surface with less ruggedness.

In the annular metal cord C1 of this embodiment, the strand material 1 is itself formed in the S-twist and the strand material 1 constituting the outer layer portion 4 is wound around the annular core portion 3 in the Z-twist. However, the strand material 1 may be itself formed in the Z-twist and the strand material 1 constituting the outer layer portion 4 may be wound around the annular core portion 3 in the S-twist.

While the annular metal cord C1 of this embodiment has a substantially circular cross section as shown in FIG. 4(a), it may have a flattened sectional shape. In such a case, the annular metal cord C1 having a substantially circular cross section is deformed, for example, by using a press. Deforming the annular metal cord C1 into the flattened sectional shape increases a contact area between the endless metal belt B1, which includes the flattened annular metal cord C1, and each of the drive pulley 12 and the driven pulley 14. As a result, power transmission between the drive pulley 12 and the driven pulley 14 can be performed with higher efficiency. Note that a aspect ratio is preferably 66% or more.

While in the endless metal belt B1 of this embodiment three annular metal cords C1 are stretched between the drive pulley 12 and the driven pulley 14, the number of annular metal cords C1 stretched is not limited to three. The number of annular metal cords C1 can be adjusted depending on bending resistance and durability which are required in individual cases.

### INDUSTRIAL APPLICABILITY

While in the embodiment the annular metal cord is applied to an endless metal belt for transmitting power in a speed reducer, the annular metal cord of the present invention can also be applied to endless metal belts for use in machines or apparatuses other than speed reducers. For example, the annular metal cord of the present invention is applicable to an endless metal belt for transmitting power between paper feed rollers in a printing machine such as a printer, an endless metal belt for performing straight driving of a uniaxial robot, an endless metal belt for performing driving of an X-Y table or driving of a three-dimensional carriage, an endless metal belt for performing precision driving in optical equipment, inspectors or measuring units, and an endless metal belt for performing power transmission between a drive pulley and a driven pulley in a continuously variable transmission for an automobile.

While the present invention has been fully described in connection with the specific embodiment, it is obvious to those skilled in the art that the present invention can be modified and changed in various ways without departing from the spirit and scope of the invention. This application is based on Japanese Patent Application (No. 2006-240166) filed Sep. 5, 2006, Japanese Patent Application (No. 2007-50569) filed Feb. 28, 2007, Japanese Patent Application (No. 2007-53062) filed Mar. 2, 2007, Japanese Patent Application (No. 2007-116047) filed Apr. 25, 2007, and Japanese Patent Application (No. 2007-148299) filed Jun. 4, 2007, which are incorporated herein by reference in their entirety.

1. An annular metal cord comprising an annular core portion formed in an annular shape, and an outer layer portion spirally wound around the annular core portion while running over an annular circumference thereof plural times and covering an outer peripheral surface of the annular core portion, each of the annular core portion and the outer layer portion being formed by a strand material which is formed by intertwisting a plurality of metal filaments,
wherein the annular core portion and the outer layer portion are formed by a continuous strand material.

2. The annular metal cord according to claim 1, wherein the annular core portion and the outer layer portion are formed by a single strand material and both ends of the strand material are joined together.

3. The annular metal cord according to claim 1, wherein one end of the strand material is a start end from which the annular core portion starts to be formed, and the other end of the strand material is a terminal end at which the formed outer layer portion is terminated.

4. The annular metal cord according to claim 1, wherein one end of the strand material is left as an extra extension when the annular core portion is formed, and the extra extension constitutes part of the outer layer portion.

5. The annular metal cord according to claim 1, wherein a metal filament has a diameter of not smaller than 0.06 mm, but not larger than 0.40 mm.

6. The annular metal cord according to claim 1, wherein a metal filament has a diameter of not smaller than 0.06 mm, but not larger than 0.22 mm.

7. The annular metal cord according to claim 1, wherein a twisting direction of the metal filaments is opposed to a winding direction of the outer layer portion wound around the annular core portion.

8. The annular metal cord according to claim 1, wherein a winding angle of the strand material with respect to a center axis of the annular core portion is not smaller than 4.5 degrees, but not larger than 13.8 degrees.

9. The annular metal cord according to claim 1, wherein the strand material is wound along the outer peripheral surface of the annular core portion while running over an annular circumference thereof five or six times.

10. The annular metal cord according to claim 1, wherein the strand material is wound into an annular shape for three rounds to form the annular core portion and is wound along the outer peripheral surface of the annular core portion while running over an annular circumference thereof not less than seven, but not more than nine times.

11. The annular metal cord according to claim 1, wherein the annular core portion and the outer layer portion are subjected to a low-temperature annealing process.

12. The annular metal cord according to claim 1, wherein ends of the strand material are joined together by using a connecting member.

13. The annular metal cord according to claim 12, wherein the ends of the strand material are joined together by welding and a joined portion of the strand material is covered with the connecting member which is made of a sleeve in the form of a coil spring and is bonded to the joined portion.

14. The annular metal cord according to claim 12, wherein the ends of the strand material are overlapped with each other in an axial direction and are held inside the connecting member made of a sleeve in the form of a coil spring, which has a sleeve inner diameter smaller than twice the diameter of the strand material.

15. The annular metal cord according to claim 13, wherein the connecting member is made of a sleeve in the form of a close-wound coil spring.

16. The annular metal cord according to claim 13, wherein a spring wire constituting the connecting member has a larger diameter than the metal filament.

17. The annular metal cord according to claim 1, wherein both ends of the strand material are intertwisted in a connected overlap portion to be plastically deformed therein for a connection between both the ends.

18. The annular metal cord according to claim 17, wherein an intertwisting direction of the strand material in the connected overlap portion is the same as a twisting direction of the metal filaments in the strand material.

19. The annular metal cord according to claim 17, wherein the connected overlap portion is located substantially intermediate between an inner periphery and an outer periphery of the annular metal cord.

20. The annular metal cord according to claim 17, wherein the strand material is twisted two to five times in the connected overlap portion.

21. An endless metal belt employing the annular metal cord according to claim 1.

22. A method of producing an annular metal cord comprising an annular core portion formed in an annular shape, and an outer layer portion spirally wound around the annular core portion while running over an annular circumference thereof plural times and covering an outer peripheral surface of the annular core portion,
wherein, in a state that a strand material formed by intertwisting a plurality of metal filaments is wound into an annular shape with a predetermined diameter and is temporarily fixed at a start end thereof or a part thereof near the start end to form the annular core portion, the strand material is spirally wound around the annular core portion while running over the annular circumference thereof plural times, thereby forming the outer layer portion to cover the outer peripheral surface of the annular core portion, and the start end and a terminal end of the strand material are then joined together.

23. The method of producing the annular metal cord according to claim 22, the method comprising the steps of:
after forming the outer layer portion;
putting the start end and the terminal end of the strand material inside a connecting member and connecting both the ends together in a state overlapped with each other in an axial direction, the connecting member being made of a sleeve in the form of a coil spring, which has a sleeve inner diameter smaller than twice the diameter of the strand material; and
cutting and removing respective extra extensions of the start end and the terminal end of the strand material, which are exposed outside the connecting member.

24. The method of producing the annular metal cord according to claim 23, the method further comprising the steps of:
after forming the outer layer portion;
inserting one of the start end and the terminal end of the strand material into the connecting member to penetrate from one end to the other end thereof; and
moving a spring wire at the other end of the connecting member to widen a coil gap between the spring wire and another adjacent spring wire, inserting the other of the start end and the terminal end of the strand material into the widened coil gap, and moving the inserted other end of the strand material along the coil gap to reach the one end of the connecting member,
whereby the start end and the terminal end of the strand material are put inside the connecting member and are connected together in the state overlapped with each other in the axial direction.

25. The method of producing the annular metal cord according to claim 24, the method further comprising the steps of:
after forming the outer layer portion;
inserting the start end of the strand material into the connecting member from one end thereof to reach an axial intermediate portion of the connecting member, and drawing out the inserted one end through a coil gap between spring wires in the axial intermediate portion of the connecting member;
inserting the terminal end of the strand material into the connecting member from the other end thereof to reach the axial intermediate portion of the connecting member, and drawing out the inserted other end through the coil gap between the spring wires in the axial intermediate portion of the connecting member; and
moving the start end of the strand material, which is projected externally of the connecting member through the coil gap, along the coil gap to reach the other end of the connecting member, and moving the terminal end of the strand material, which is projected externally of the connecting member through the coil gap, along the coil gap to reach the one end of the connecting member, whereby the start end and the terminal end of the strand material are put inside the connecting member and are connected together in the state overlapped with each other in the axial direction.

26. The method of producing the annular metal cord according to claim 18, the method comprising the steps of:
arranging a pair of plate members in a spaced relation, each of the plate members having a pair of holding elements which are capable of holding the strand material and are formed in the plate member in a spaced relation,
holding portions of the strand material near respective ends thereof by the holding members of the plate members such that the strand material portions near the ends thereof are stretched between the plate members in the state overlapped with each other in the axial direction, and
relatively rotating the plate members in opposed directions with a center of rotation located between the pair of holding elements of each plate member, whereby the strand material portions near the ends thereof are intertwisted between the pair of plate members to form a connected overlap portion in which the strand material portions near the ends thereof are plastically deformed for connection therebetween.

27. The method of producing the annular metal cord according to claim 26, wherein the plate member includes, as the holding element, a slit which is formed to be opened at an outer periphery of the plate member and to extend up to a position near the center of rotation, and the strand material is inserted into the slit to be held in the slit.

28. The method of producing the annular metal cord according to claim 27, wherein the plate member includes the slit as one of the holding elements and an insertion hole as the other of the holding elements, the insertion hole allowing insertion of the strand material through the same.

29. The method of producing the annular metal cord according to claim 26, wherein when the strand material portions near the ends thereof are intertwisted to be connected together, a twisting margin at each end of the strand material is set to be longer than the length of the connected overlap portion.

30. The method of producing the annular metal cord according to claim 26, wherein after intertwisting twisting margins at ends of the strand material to be plastically deformed, non-twisted extra extensions of the twisting margins are cut and removed.

31. The method of producing the annular metal cord according to claim 26, wherein when the ends of the strand material are intertwisted and connected together, a plurality of catching members are engaged with connection non-target portions of the strand material other than connection target portions thereof which are to be connected together, and the connection non-target portions are moved by the catching members in a direction away from the connection target portions.
